(19) United States
(12) Patent Application Publication
(10) Pub. No.: US 2021/0055406 A1
(43) Pub. Date: Feb. 25, 2021

(54) OBJECT SENSING DEVICE

(71) Applicant: PANASONIC INTELLECTUAL PROPERTY MANAGEMENT CO., LTD., Osaka (JP)

(72) Inventor: Shinzo KOYAMA, Osaka (JP)

(21) Appl. No.: 16/977,322

(22) PCT Filed: Nov. 7, 2018
(86) PCT No.: PCT/JP2018/041358

§ 371 Date: Sep. 1, 2020

(30) Foreign Application Priority Data
Mar. 2, 2018 (JP) 2018-037087

(51) Int. Cl. G01S 13/86; G01S 17/89; G01S 17/931; G01S 13/931

(52) U.S. Cl. CPC G01S 13/865; G01S 17/89; G01S 2013/9323; G01S 13/931; G01S 17/931

(57) ABSTRACT

Provided is an object sensing device that can obtain an image having a higher resolution in bad weather such as fog and rain. This object sensing device for sensing an object includes a radar that emits an electromagnetic wave to the object and generates a signal indicating a location of the object, a light source that emits light to the object, a sensor that obtains an image of the object, and a processor. The processor controls, based on the signal, timing of emission of the light by the light source, and exposure of the sensor.

### TECHNICAL FIELD

The present disclosure relates to object sensing devices.

### BACKGROUND ART

A car equipped with a radar and a camera is known. For example, in PATENT DOCUMENT 1, the radar is used to measure the distance between the car equipped with the radar and a vehicle traveling in front thereof, and the camera is used to recognize a lane or a road edge.

### CITATION LIST

Patent Document PATENT DOCUMENT 1: Japanese Patent Publication No. H11-212640

### SUMMARY OF THE INVENTION

### Technical Problem

There is a demand for an object sensing device that can identify and sense what an object is like, irrespective of the weather. Specifically, such an object sensing device is expected to not only check the presence of an object but also identify and sense what kind of object is present, even in bad weather such as fog and rain.

In this case, the recognition of an object may be improved by enhancing the visual recognition performance of the camera by increasing the amount of light emitted by headlights, for example. However, if only the amount of light emitted by headlights is simply increased, not only the amount of light from an object of interest but also the amount of light traveling back due to backscattering by fog particles increase to the extent that the object of interest is no longer visible. This deteriorates the visibility of the object, and therefore, the object cannot be recognized or identified.

Under such circumstances, the rate of detection of an object may be improved by detecting the object using a detector such as a radar, which is not substantially affected by rain or fog. The radar has a significantly lower resolution than that of the camera. Therefore, the radar can sense the presence of an object, but cannot identify or recognize the object. As a result, in the case where the radar is applied to a vehicle, etc., the vehicle stops or decelerates too frequently for an object for which the vehicle does not need to stop, leading to uncomfortable traveling.

### Solution to the Problem

The present disclosure discloses implementations of an object sensing device that solves the above problem.

An object sensing device for sensing an object includes a radar configured to emit an electromagnetic wave to the object and generate a signal indicating a location of the object, a light source configured to emit light to the object, a sensor configured to obtain an image of the object, and a processor. The processor controls, based on the signal, timing of emission of the light by the light source, and exposure of the sensor.

### Advantages of the Invention

Provided is an object sensing device that can obtain an image having a higher resolution in bad weather such as fog and rain.

### BRIEF DESCRIPTION OF THE DRAWINGS

FIG. 1 is a diagram showing a configuration of an object sensing device.

FIG. 2 is a diagram showing a positional relationship between an own vehicle and an object.

FIG. 3 is a timing chart showing operations of a radar, light source, and sensor.

FIG. 4 is a diagram showing a position where a light source is attached to an own vehicle.

FIG. 5 is a diagram showing a position where a light source is attached to an own vehicle.

FIG. 6 is a diagram showing an illuminated region that is illuminated by a light source using diffused light.

FIG. 7 is a diagram showing an illuminated region that is illuminated by a light source performing line scan.

FIG. 8 is a diagram showing an illuminated region that is illuminated by a light source performing line scan.

FIG. 9 is a diagram showing an illuminated region that is illuminated by a light source performing point scan.

FIG. 10 is a diagram showing imaging performed by a sensor when a plurality of objects are present near an own vehicle.

### DESCRIPTION OF EMBODIMENTS

Embodiments of the present disclosure will now be described with reference to the accompanying drawings. It should be noted that all of the embodiments described below are a specific preferred example of the present disclosure. Therefore, numerical values, shapes, materials, components, arrangements of components, and connections or couplings of components, etc., described in the embodiments below are merely illustrative and are in no way intended to limit the present disclosure. Therefore, of the components in the embodiments below, those that are not described in the independent claims indicating the broadest concept of the present disclosure are described as optional components.

Each figure is schematic and is not necessarily exactly to scale. Like parts are indicated by like reference characters throughout the drawings and will not be redundantly described or will be briefly described.

In the specification and drawings, the X axis, Y axis, and Z axis represent the three axes of a three-dimensional orthogonal coordinate system. In this embodiment, the Z axial direction is a vertical direction, and a direction perpendicular to the Z axis (a direction parallel to the X-Y plane) is a horizontal direction. The X and Y axes are orthogonal to each other and are both orthogonal to the Z axis.

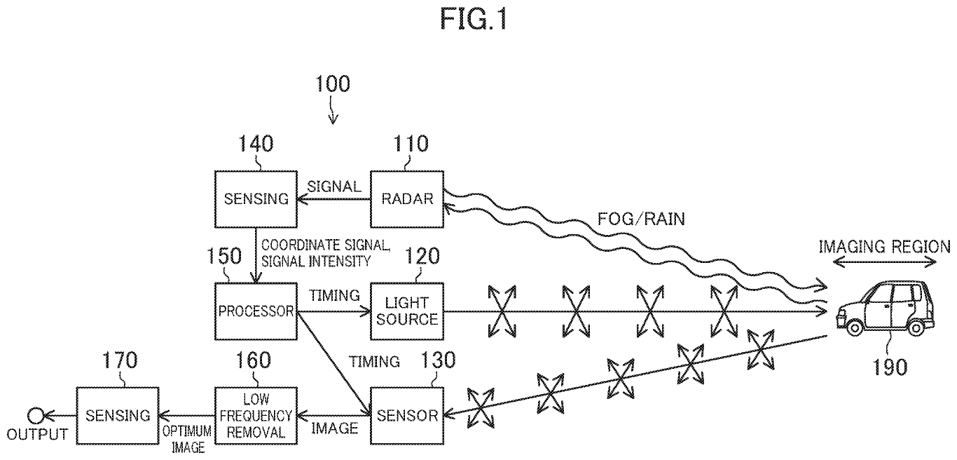

FIG. 1 is a diagram showing a configuration of an object sensing device 100. The object sensing device 100 includes a radar 110, a light source 120, a sensor 130, a sensing circuit 140, a processor 150, a low frequency removal circuit 160, and a sensing circuit 170. The object sensing device 100, which is provided in, for example, a car, senses an object 190 present in front of the car. A vehicle equipped with the object sensing device 100 is referred to as an “own vehicle.”

The object 190 is typically another vehicle, but is not limited to this. The object 190 may be, for example, a pedestrian, a structure on a road, etc. The object 190 may be an obstacle, depending on the positional relationship between the own vehicle equipped with the object sensing device 100 and the object 190. In that case, based on the result of sensing by the object sensing device 100, warning to the driver of the own vehicle or braking of the own vehicle may be performed, for example.

The radar 110 is, for example, a millimeter wave radar. The radar 110 emits a pulsed millimeter wave to the object 190, and receives a reflected electromagnetic wave traveling back. The radar 110 outputs, to the sensing circuit 140, a signal indicating the times of emission and reception of an electromagnetic wave. Based on the times of emission and reception, the processor 150 generates a signal indicating a location with respect to the object 190. In the case where the radar 110 emits an electromagnetic wave in only one direction, the location corresponds to a one-dimensional location of the object 190 with respect to the radar 110, i.e., a distance between the radar 110 and the object 190. In the case where the radar 110 performs sector scan, i.e., the direction of emission sweeps through a sector in a horizontal plane with time, the location is a two-dimensional location of the object 190 with respect to the radar 110, i.e., a location of the object 190 in the horizontal plane with respect to the radar 110.

The light source 120 emits pulsed light to the object 190. The intensity of light emitted by the light source 120 may be changed with time in a rectangular or triangular waveform. The light source 120 may be, for example, a laser device or light emitting diode (LED). The light source 120 herein also includes a laser diode, which emits laser light. The light source 120, which typically emits a visible light beam, may also serve as a light source of a headlight of the own vehicle 210. The light source 120 may be dedicated to sensing and may emit near-infrared light. Laser devices, which can provide a high-speed response, are preferably used as a pulsed light source. The light source 120 may be an LED, provided that the light source 120 is driven by a circuit having high drive power.

The sensor 130 receives light only during a light reception period after a delay time has elapsed since emission of pulsed light, to image the object 190. The delay time corresponds to the distance between the radar 110 and the object 190. The light reception period corresponds to the length of the object 190 in the depth direction as viewed from the radar 110. The sensor 130 typically includes a two-dimensional array of imaging elements. The sensor 130 has a shutter, preferably a global shutter, whose shutter speed is relatively high.

The sensor 130 outputs a captured image to the low frequency removal circuit 160. The low frequency removal circuit 160 outputs an image enhanced by signal processing to the sensing circuit 170. The sensing circuit 170 senses an object, and outputs a result of the sensing.

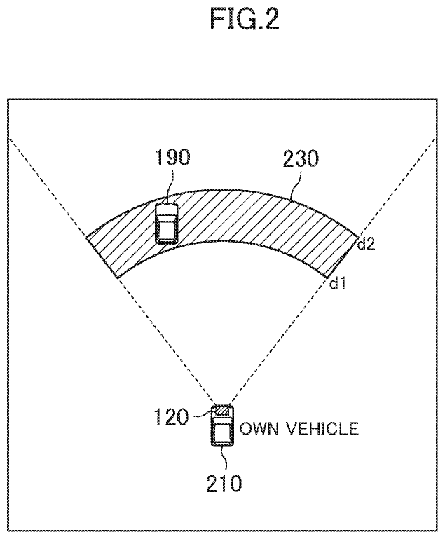

FIG. 2 is a diagram showing a positional relationship between the own vehicle 210 and the object 190. It is assumed that the object 190, which is to be imaged by the sensor 130, is located in an imaging range 230 that is a distance range of d1-d2 from the own vehicle 210. At this time, the processor 150 controls the shutter of the sensor 130 so that the sensor 130 receives light only from the imaging range 230.

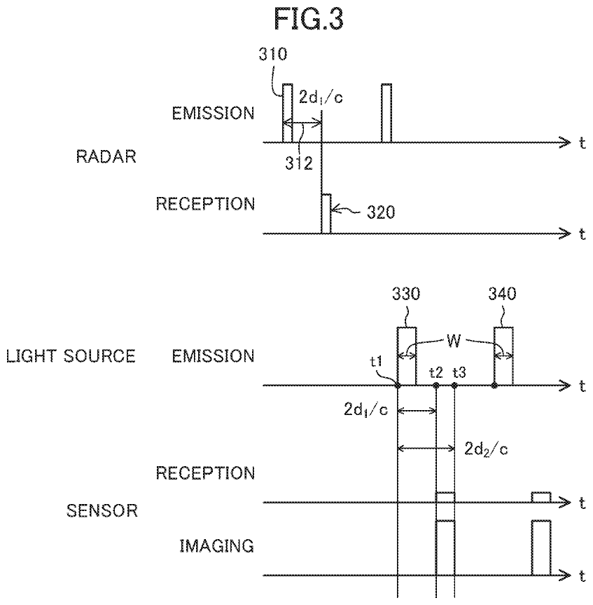

FIG. 3 is a timing chart showing operations of the radar 110, the light source 120, and the sensor 130. In FIG. 3, the horizontal axis represents time, and the vertical axis represents an operation of each component. After a delay time 312 has elapsed since emission of a pulsed electromagnetic wave 310 by the radar 110, a reflected electromagnetic wave 320 from the object 190 is received. The delay time 312 is equal to 2d1/c, where c represents the speed of light, and d1 represents the distance between the radar 110 and the object 190. The radar 110 emits a pulsed electromagnetic wave 310 at intervals of, for example, 100 ms. The present disclosure is not limited to this. The radar 110 may emit an electromagnetic wave at any suitable intervals.

The light source 120 emits pulsed light beams 330, 340 periodically to the object 190. The interval between the pulsed light beams 330 and 340 (also referred to as an “emission interval,” i.e., a time period from time t1 to time t4) is, for example, 10 μs. The present disclosure is not limited to this. The emission interval may be any suitable interval. For example, the emission interval of the light source 120 is in the range of 2-10 μs. As described below, the pulse width W of the pulsed light beams 330 and 340 is suitably selected, depending on the imaging range 230.

For example, in the case where images are captured at a rate of 30 frames per second, each frame has a duration of 33.3 ms. If the emission interval is 10 μs, the number of times pulsed light can be emitted per frame is of the order of 1000. The sensor 130 receives and accumulates photons generated by pulsed light emission performed a large number of times, and calculates summation, so that an image can be formed. An example element used for the sensor 130 to implement the operation of accumulating photons is an avalanche photodiode.

Assuming that the front edge of the pulsed light beam 330 is located at time t1, the sensor 130 performs imaging only for a light reception period (t3−t2) from time t2 to time t3. The time period from time t1 to time t2 is equal to 2d1/c. The time period from time t1 to time t3 is equal to 2d2/c. Therefore, the depth (d2−d1) of the imaging range 230 as viewed from the own vehicle 210 is expressed by (t3−t2)c/2. In other words, if the light reception period (t3−t2) is suitably set, the imaging range 230 suitable for the object 190 is obtained. Typically, the light reception period (t3−t2) is equal to the pulse width W of the pulsed light beams 330 and 340. If the processor 150 controls the emission and reception of light of the light source 120 in such a manner, the sensor 130 can selectively image only an object that is present in the imaging range 230. If the pulse width W is set to, for example, the length in the depth direction of a car which is the object 190, the influence of bad weather such as fog and rain on imaging can be minimized.

For example, if the pulse width (i.e., the time period from t2 to time t3) of the pulsed light beams 330 and 340 is 10 ns, the imaging range 230 (i.e., (d2−d1)) is 3 m, which corresponds to the depth of field. For example, if the pulse width (i.e., the time period from t2 to time 13) of the pulsed light beams 330 and 340 is 50 ns, the imaging range 230 (i.e., (d2−d1)) is 15 m. If it is assumed that a car is included as the object 190 in the imaging range 230, the pulse width (emission period) of the pulsed light beams 330 and 340 is preferably, for example, 10-50 ns. The present disclosure is not limited to this. The pulse width (emission period) of the pulsed light beams 330 and 340 may be any suitable time period. For example, the emission period of the light source 120 may be in the range of 10-100 ns.

The above structure allows the power of light emitted by the light source 120 to be concentrated only at or near the object 190. The intensity of a signal reflected by the object 190 present in fog or rain can be increased, and therefore, the object 190 can be sensed even if the object 190 is located further away. Imaging of the object 190 can be less affected by the influence of light from the light source 120 that has been reflected by fog or rain.

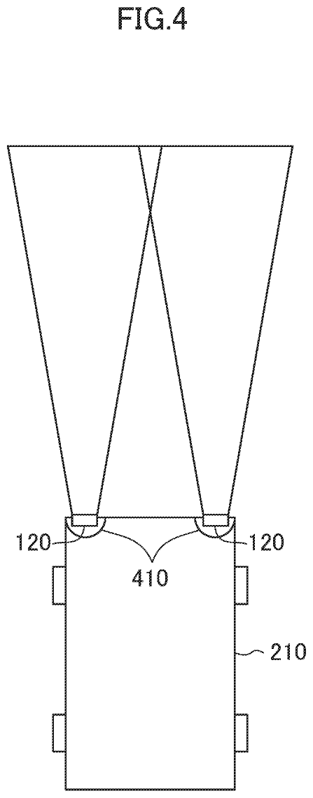

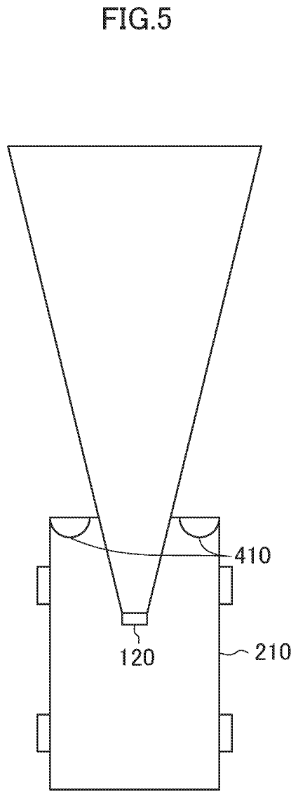

FIG. 4 is a diagram showing a position where the light source 120 is attached to the own vehicle 210. The light source 120 may, for example, also serve as a headlight 410, which emits visible light. In that structure, the headlight and the light source 120 can share the same parts, and therefore, the number of parts can preferably be reduced. In that case, the light source 120 and the sensor 130 are located at different positions, and therefore, the arrangement of the light source 120 and the sensor 130 is preferably determined, taking into account the synchronization of control signals. Specifically, taking into account the delay time it takes for a control signal from the processor 150 to reach the light source 120, the delay time it takes a control signal from the processor 150 to reach the sensor 130, etc., an offset is given to a control time. This allows imaging in a consistent distance range. FIG. 5 is a diagram showing a position where the light source 120 is attached to the own vehicle 210. The light source 120 may, for example, be separated from headlights 410. In that case, the light source 120 is attached in the interior of the own vehicle 210. In addition, the light source 120 may be integrated with the sensor 130. Specifically, the light source 120 and the sensor 130 are mounted in substantially the same housing. In that case, the delay time between the control signals of the light source 120 and the sensor 130 is insignificant, which facilitates design.

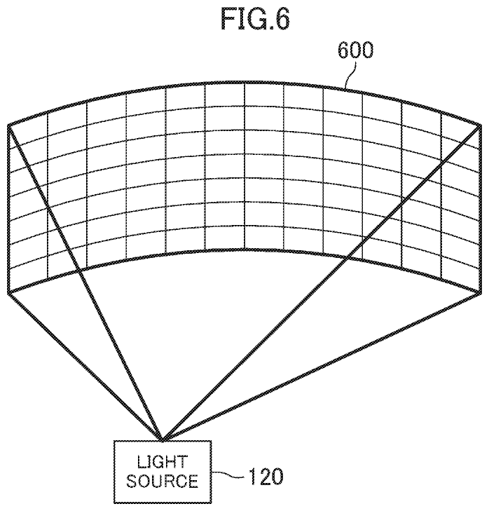

FIG. 6 is a diagram showing an illuminated region 600 that is illuminated by the light source 120 using diffused light. The light source 120 illuminates the illuminated region 600 using diffused light. There is preferably a one-to-one correspondence between the illuminated region 600 and the imaging range. For example, preferably, an optical lens system is disposed in front of the light source 120, and emission is preferably adapted for the angle of view of the sensor 130 in imaging. The illuminated region 600 can be imaged at once using diffused light, and therefore, it is not necessary to provide a scan mechanism to the light source 120.

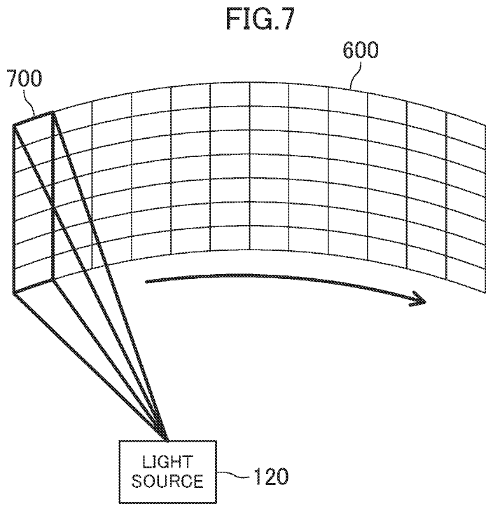

FIG. 7 is a diagram showing an illuminated region 600 that is illuminated by the light source 120 performing line scan. The light source 120 causes a stripe region 700 extending in a vertical direction to sweep in a horizontal direction, thereby scanning the entire illuminated region 600. There is preferably a one-to-one correspondence between the illuminated region 600 and the imaging range. The sensor 130 images only a region corresponding to the stripe region 700 at once. The light source 120 sweeps through the angle of view covering the imaging region in a frame to scan the entire region. The scan using the stripe region 700 may cover the entire imaging region, or conversely, may cover only a portion of the imaging region. The light source 120 may be driven to sweep through from one or more lines that together cover the imaging region, the number of lines varying depending the width of the stripe region 700 of the light source 120. The line scan can improve a signal-to-noise ratio (SNR).

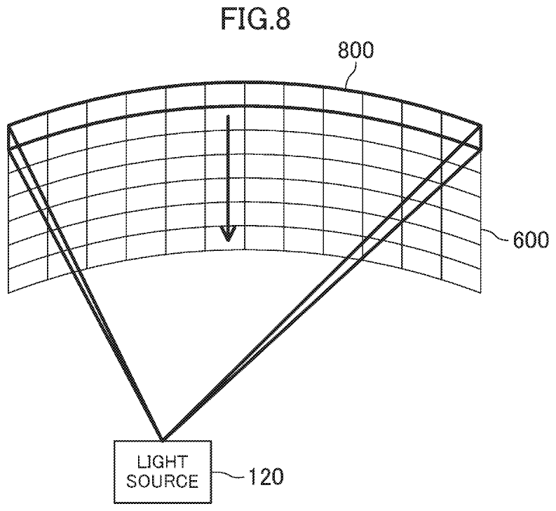

FIG. 8 is a diagram showing an illuminated region 600 that is illuminated by the light source 120 performing line scan. The light source 120 causes a stripe region 800 extending in a horizontal direction to sweep in a vertical direction, thereby scanning the entire illuminated region 600. There is preferably a one-to-one correspondence between the illuminated region 600 and the imaging range. The sensor 130 images only a region corresponding to the stripe region 800 at once. The light source 120 sweeps through the angle of view covering the imaging region in a frame to scan the entire region. The scan using the stripe region 800 may cover the entire imaging region, or conversely, may cover only a portion of the imaging region. The light source 120 may be driven to sweep through from one or more lines that together cover the imaging region, the number of lines varying depending the width of the stripe region 800 of the light source 120. The line scan can improve a signal-to-noise ratio (SNR).

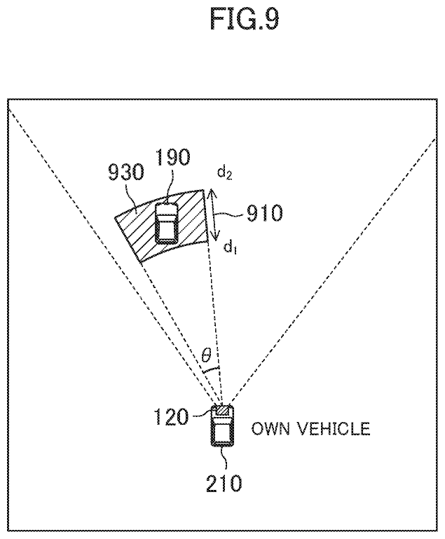

FIG. 9 is a diagram showing an illuminated region 930 that is illuminated by the light source 120 performing point scan. The light source 120 causes a dot-shaped light region to sweep through an angle of θ to scan the entire illuminated region 930. In the case of point scan, the light emission power of the light source 120 can be enhanced. As a result, even during the daytime, the object 190 that is located further away can be imaged. In the case where point scan is performed using a two-dimensional MEMS mirror, etc., a scan region can be narrowed in a vertical and a horizontal direction to an angle of θ determined by radar reception, and imaging is performed in the narrowed scan region. As a result, the object 190 of interest can be imaged by scanning a very small region with reduced power of the light source 120.

In the above embodiments, an operation mode may be implemented in which when two objects located at different distances are sensed by the radar 110, for example, the nearer object is imaged with priority, and the further object is not imaged. Alternatively, the nearer object and the further object may be imaged alternately on a frame-by-frame basis, whereby each of the plurality of objects can be clearly imaged. Here, the sensor 130 performs imaging at a rate of, for example, 30 frames per second.

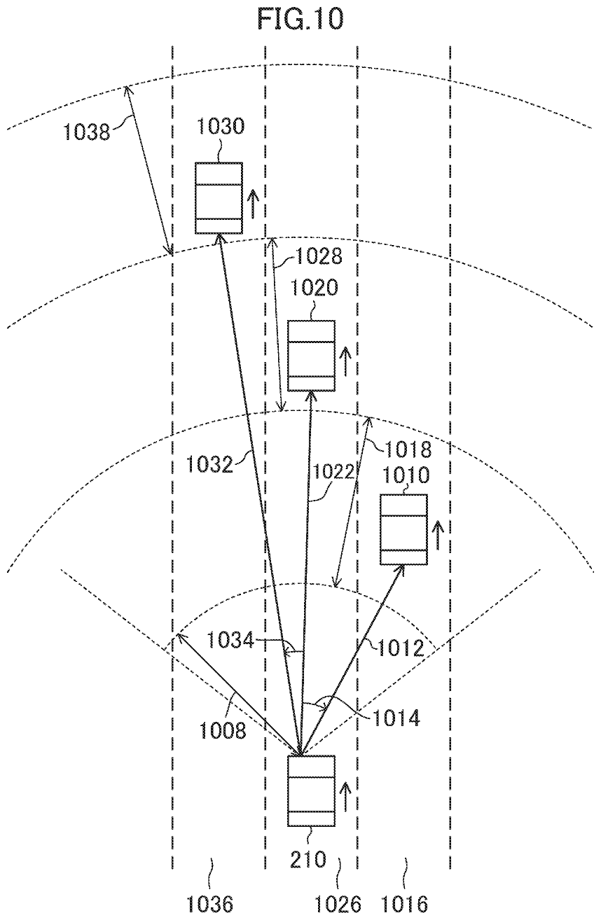

FIG. 10 is a diagram showing imaging performed by the sensor 130 when a plurality of objects are present near the own vehicle 210. Three vehicles 1010, 1020, and 1030 are traveling near the own vehicle 210 in the same direction. The vehicle 1010 is located a distance 1012 away from the own vehicle 210, forming an angle 1014. The vehicle 1020 is located a distance 1022 away from the own vehicle 210, directly in front of the own vehicle 210. The vehicle 1030 is located a distance 1032 away from the own vehicle 210, forming an angle 1034. The vehicles 1010, 1020, and 1030 are traveling in lanes 1016, 1026, and 1036, respectively. The own vehicle 210 is traveling in the lane 1026. No vehicle is present in a region 1008. The vehicles 1010, 1020, and 1030 are present in regions 1018, 1028, and 1038, respectively.

The processor 150 determines whether or not a vehicle is present in the same lane as that of the own vehicle 210, based on a distance between the own vehicle 210 and that vehicle, and an angle of that vehicle with respect to a forward direction of the own vehicle 210. For example, in the case where the distance 1012 is 10 m and the angle 1014 is 20 degrees, 10 m×sin 20°=3.4 m, and therefore, the processor 150 determines that the vehicle 1010 is not present in the same lane 210, and is present in the adjacent lane 1016.

When the radar 110 senses the vehicles 1010, 1020, and 1030, the processor 150 calculates the degree of risk of a collision with each of the vehicles 1010, 1020, and 1030 based on the distances 1012, 1022, and 1032, and the angle 1014, the angle of 0° (the vehicle 1020 is present in front of the own vehicle 210), and the angle 1034. For example, it is determined that the degree of risk is high for the vehicle traveling in the same lane 1026. In addition, the shorter the distance, the higher the degree of risk determined. Therefore, the degree of risk for the vehicle 1010 is higher than that for the vehicle 1030. In the case where the degree of risk is determined in accordance with the above rule, the following relative order of magnitude of the degree of risk is obtained: the degree of risk for the vehicle 1020>the degree of risk for the vehicle 1010>the degree of risk for the vehicle 1030.

Based on the resultant degrees of risk, the processor 150 controls the timings of emission of the light source 120 and exposure of the sensor 130 so as to obtain images of two of the vehicles 1010, 1020, and 1030 in different frames. In the case of FIG. 10, the timings of emission and exposure are controlled so that images of the regions 1008, 1018, 1028, and 1038 are obtained in different frames. As a result, the vehicles 1010, 1020, and 1030 can each be clearly imaged using a different frame.

In one embodiment, when the radar 110 senses a plurality of objects, the processor 150 controls the exposure of the sensor 130 based on a position signal of the closest object. As a result, image processing can be performed on a vehicle having the highest degree of risk with priority.

In one embodiment, when three or more objects having different distances are sensed, for example, only the closest and intermediate objects can be alternately imaged, excluding the furthest object from those is to be imaged, depending on the distance. For example, the vehicle 1030 is located furthest away and therefore may not be imaged, and only the vehicles 1010 and 1020 may be imaged.

The object sensing device 100 may be mounted on a mobile body. Preferably, the object sensing device 100 is mounted on a car. In one embodiment, the light source 120 illuminates the interior of the mobile body, and the sensor 130 is separated from the light source 120.

According to the above various embodiments, the light source 120 is driven in a pulsed mode, whereby the intensity of a signal corresponding to light from the object 190 can be improved by effectively using the same amount of light. In addition, offset noise (background noise) due to fog or rain can be reduced by pulsed exposure of the sensor 130.

The elements (or acts) in the above embodiments may be arbitrarily combined without departing the spirit and scope of the present invention.

What have been described above include various examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

### DESCRIPTION OF REFERENCE CHARACTERS

100 OBJECT SENSING DEVICE
110 RADAR
120 LIGHT SOURCE
130 SENSOR
140 SENSING CIRCUIT
150 PROCESSOR
160 LOW FREQUENCY REMOVAL CIRCUIT
170 SENSING CIRCUIT

1. An object sensing device for sensing an object, comprising:
a radar configured to emit an electromagnetic wave to the object and generate a signal indicating a location of the object;
a light source configured to emit light to the object;
a sensor configured to obtain an image of the object; and
a processor,
wherein
the processor controls, based on the signal, timing of emission of the light by the light source, and exposure of the sensor.

2. The object sensing device of claim 1,
wherein
when the radar senses a plurality of objects, the processor controls exposure of the sensor based on the signal from a closest one of the objects.

3. The object sensing device of claim 1,
wherein
the signal indicates a distance between the radar and the object, and an angle of the object with respect to the radar,
when the radar senses a plurality of objects, the processor calculates a degree of risk of collision with each of the plurality of objects based on the distance and the angle, and
based on the degrees of risk, the processor controls the timing and the exposure so as to obtain images of two of the plurality of objects in different frames.

4. The object sensing device of claim 1,
wherein
the sensor and the light source are mounted in substantially the same housing.

5. The object sensing device of claim 1,
wherein
the light source emits diffused light.

6. The object sensing device of claim 1,
wherein
the light source causes a linear light beam to sweep in a direction perpendicular to the linear light beam based on predetermined timings, and
the sensor performs scan in the perpendicular direction.

7. The object sensing device of claim 1,
wherein
the light source causes a dot-shaped light beam to sweep through a specific region based on predetermined timings, and
the sensor images only the region.

8. The object sensing device of claim 1,
wherein
the object sensing device is configured to be mounted on a mobile body.

9. The object sensing device of claim 1,
wherein
the light source is configured to illuminate an interior of the mobile body, and
the sensor is separated from the light source.

10. The object sensing device of claim 1,
wherein
the light source has an emission period in the range of 10-100 ns.

11. The object sensing device of claim 1,
wherein
the light source has an emission interval in the range of 2-10 μs.
